(19) United States
(12) Patent Application Publication
(10) Pub. No.: US 2025/0091924 A1
(43) Pub. Date: Mar. 20, 2025

(54) DESCALING FORMULATION AND METHOD FOR DISSOLVING AND CLEANING SCALE DEPOSITION ON A SURFACE OF SYSTEM

(71) Applicant: HINDUSTAN PETROLEUM CORPORATION LIMITED, Tarabahalli, Devanagundi Bengaluru (IN)

(72) Inventors: Eswararao DONI, Bengaluru (IN); Siva Kesava Raju CHINTHALAPATI, Bengaluru (IN); Hareesha DASARY, Bengaluru (IN); Eklovepreet SINGH, Bengaluru (IN); Ravi BALASUBRAMANIAM, Bengaluru (IN)

(21) Appl. No.: 18/577,234

(22) PCT Filed: Jan. 18, 2023
(86) PCT No.: PCT/IN2023/050056

§ 371 Date: Jan. 5, 2024

(30) Foreign Application Priority Data
Mar. 10, 2022 (IN) 202241013105

(51) Int. Cl. C02F 5/10; C02F 1/66; C02F 5/12; C02F 103/02

(52) U.S. Cl. CPC C02F 5/105; C02F 1/66; C02F 5/125; C02F 2103/023; C02F 2303/08; C02F 2305/04

(57) ABSTRACT

The present invention discloses a descaling formulation consisting of dealkalizer, surfactant and corrosion inhibitor and use of the said descaling formulation to dissolve and clean scales formed on the surfaces of industrial water systems. The said dealkalizer is selected from a mineral acid, an organic acid or combination of them. The said surfactant is selected from a polymer surfactant, a zwitter ionic surfactant or non-ionic surfactant or combination of them. The said corrosion inhibitor is a quaternary ammonium salt or a Polyethylene glycol alkyl ether.

### FIELD OF THE INVENTION

The present invention relates to a descaling formulation and method of dissolving and cleaning scale deposition on a surface of a system. Specifically, the present invention relates to a polymer based descaling formulation which have excellent scale dissolution efficiency for different types of scales, economic and have lower corrosive impact on the surface of an industrial system.

### BACKGROUND OF THE INVENTION

Different industrial processes require different industrial system and each industrial system have its own specific requirements for fluid flow and the fluid type. For example, the petrochemical industry requires different types of industrial systems such as flow pipes for flow of crude oils as well as flow of refined petrochemical products, refining systems for refining of the crude oils, and industrial water systems for heat transfer as required during the processing of the petrochemical products.

Thus, each industrial system has a different type of fluid flowing therethrough and such continuous flow of fluid also deposits different types of scales on the surfaces of these industrial systems. Scales are complex mixtures of variety of minerals in the flow streams that provide sources for scale build-up and thus leads to stopping of the whole system and continuous cleaning of the deposited scales.

In the industrial water systems, there are different types of scale deposits depending on the type of water flowing through such industrial water systems. Accordingly, removing scale precipitations from industrial water system surface is a very hard and complicated process due to different types of scale formation and the operational severity of the process. The two approaches for scale removal are mechanical removal and chemical solutions, and commonly, both methods are used together for descaling jobs. Generally, the chemical solutions do not provide complete removal of the deposits and after application of the chemical solutions mechanical removal of the scales is also followed.

Chemical solutions include descaling additives, among the descaling additives that are used in the petrochemical industry, hydrochloric acid (HCl) is the one of conventional mineral acid that has been used to remove oilfield scales since decades as it dissolves most types of scales. However, hydrochloric acid (HCl) has a corrosive effect and produces H₂S, which is a toxic gas and thus not environment friendly. Accordingly, due to the toxicity and corrosion, the focus has been shifted to find alternative chemical solutions to remove the scale deposition. Due to lower corrosion, organic acids like citric acid, maleic acid, formic acid, and acetic acid are also used as an alternative chemical solution. However, they are expensive and not effective to dissolve certain scales such as carbonates.

Accordingly, there is continuous demand of improved chemical solutions for scale removal which minimizes the mechanical removal of the scales, as well as reduces corrosion, and are economic to produce.

### SUMMARY OF THE PRESENT INVENTION

The present invention provides a descaling formulation to dissolve a scale deposit formed on a surface of an industrial water system. Wherein, the descaling formulation include 5 to 15 parts by weight of a dealkalizer selected from an acid component, 0.05 to 5 parts by weight of a surfactant selected from a polymer surfactant, a zwitter ionic surfactant, a non-ionic surfactant or a combination thereof, 0.05 to 0.5 parts by weight of a corrosion inhibitor selected from a quaternary ammonium salt, or a Polyethylene glycol alkyl ether and 78 to 85 parts by weight of water.

The said acid component consists of a mineral acid, an organic acid, or a combination thereof. The mineral acid is selected from a Sulphamic acid, a Hydrochloric acid, Sulfuric Acid, Nitric acid, Phosphoric acid, Sulfonic acid or a combination thereof. The organic acid is selected from citric acid, oxalic acid, or a combination thereof

The polymer surfactant is selected from a copolymer of maleic anhydride and acrylic acid commonly known as MA-AA copolymer (wherein, MA is maleic anhydride and AA is acrylic acid), or a polymer of the MA-AA copolymer. The polymer of the MA-AA copolymer is a reaction product of an MA-AA copolymer with one of compound selected from ethyleneamines, tallow amines, or alkanolamines at a reaction temperature of 50°-80° C. for 1-3 hours.

The zwitter ionic surfactant is Cocamidopropylbetaine (CAPB) and the non-ionic surfactant is Tergitol. The quaternary ammonium salt is benzalkonium chloride and the Polyethylene glycol alkyl ether is Triton-X 100.

A method to dissolve and to clean a scale deposit formed on a surface of an industrial water system, wherein, the said method comprising the step of applying the said descaling formulation on the surface of the industrial water system.

### Objectives of the Present Invention

It is the primary objective of the present invention to provide a descaling formulation which is polymer based, economic and have lower corrosive impact on the surface of the system.

It is further objective of the present invention to provide a descaling formulation which have excellent scale dissolution efficiency for different types of scales.

It is further objective of the present invention to provide a method to dissolve and clean scales formed on surfaces of a system such as an industrial water system.

### BRIEF DESCRIPTION OF THE DRAWING

To further clarify advantages and aspects of the present invention, a more particular description of the present descaling formulation and the method of dissolving and cleaning scale deposition on a surface of an industrial water system will be rendered by reference to specific embodiments thereof, which is illustrated in the appended drawing(s). It is appreciated that the drawing(s) presented herein depicts only typical embodiments and are therefore not to be considered limiting of its scope.

FIG. 1: illustrates the condenser pipes before and after the application of the descaling formulation; and

FIG. 2: illustrates the improvement of condenser approach with the application of the descaling formulation.

### DESCRIPTION OF THE INVENTION

Commercial descaling formulations and the descaling chemical solutions are mostly based on acids. The acid based descaling formulations are effective as descalants but not good for the health of the industrial systems and the alternative options for organic and inorganic acids are chelating agents. Chelating agents are composed of one or more of complexing groups that interact with scale metal ions. The common chelating agents as reported include amino acid-derived, acetic acid-derived, or amine-derived compounds.

The chelating agents have a low corrosion effect and only some of them are considered as environment friendly. Therefore, it is necessary to find an alternative chelating agent which are environment friendly as well as efficient and economical to be used in descaling formulations for removing the scale precipitations.

According to the main embodiment, the present disclosure provides descaling formulations which are economic and have lower corrosive impact on the surface of the system

Further, the present disclosure provides polymer based descaling formulations, wherein, the said polymer acts as surfactant as well as a chelating agent.

Specifically, the present disclosure provides a descaling formulation which works on every type of scale deposits and thus minimizes the mechanical removal of the scales.

Accordingly, the present disclosure provides a descaling formulation to dissolve a scale deposit formed on a surface of an industrial water system. Wherein, the descaling formulation include 5 to 15 parts by weight of a dealkalizer selected from an acid component, 0.05 to 5 parts by weight of a surfactant selected from a polymer surfactant, a zwitter ionic surfactant, a non-ionic surfactant or a combination thereof, 0.05 to 0.5 parts by weight of a corrosion inhibitor selected from a quaternary ammonium salt, or a Polyethylene glycol alkyl ether, and 78 to 85 parts by weight of water.

The said acid component consists of a mineral acid, an organic acid, or a combination thereof. The mineral acid is selected from a Sulphamic acid, a Hydrochloric acid, Sulfuric Acid, Nitric acid, Phosphoric acid, Sulfonic acid or a combination thereof. The organic acid is selected from citric acid, oxalic acid, or a combination thereof

The polymer surfactant is selected from an MA-AA copolymer, or a polymer of the MA-AA copolymer. The polymer of the MA-AA copolymer is a reaction product of an MA-AA copolymer with one of compound selected from ethyleneamines, tallow amines, or alkanolamines at a reaction temperature of 50°-80° C. for 1-3 hours.

The zwitter ionic surfactant is Cocamidopropylbetaine (CAPB) and the non-ionic surfactant is Tergitol. The quaternary ammonium salt is benzalkonium chloride and the Polyethylene glycol alkyl ether is Triton-X 100.

Further, the present disclosure provides a method to dissolve and clean a scale deposit formed on a surface of an industrial water system, wherein, the said method comprising the step of applying a descaling formulation on the surface of the industrial water system. The said descaling formulation comprising 5 to 15 parts by weight of a dealkalizer selected from an acid component, 0.05 to 5 parts by weight of a surfactant selected from a polymer surfactant, a zwitter ionic surfactant, a non-ionic surfactant or a combination thereof, 0.05 to 0.5 parts by weight of a corrosion inhibitor selected from a quaternary ammonium salt or a Polyethylene glycol alkyl ether, and 78 to 85 parts by weight of water.

In an embodiment, the descaling formulation is made of 10 parts by weight of sulphamic acid, 5 parts by weight of Hydrochloric acid, 0.5 parts by weight of MA-AA copolymer, 0.05-0.5 parts by weight of Triton-X 100, and 84 to 84.45 parts by weight of water.

In another embodiment, the method to dissolve and clean a scale deposit formed on a surface of an industrial water system includes circulating the descaling formulation along with a liquid medium contacting the surface of the industrial water system, wherein, the said liquid medium is selected from a fresh water, a saline water, or a combination thereof.

In another embodiment, the method to dissolve and clean a scale deposit formed on a surface of an industrial water system includes circulating the descaling formulation through the industrial water system, wherein, the descaling formulation is in direct contact with the surface of the industrial water system.

Synthesis of MA-AA Copolymer and MA-AA-AEP Polymer which Acts as Chelating Agent:

Synthesis of MA-AA copolymer: Potassium persulfate (0.012 mol) was added to two-neck flask and dissolved in 50 mL deionized water at 70° C. To this flask, mixture of Maleic anhydride (MA) (0.306 mol) and AA (0.336 mol) in 100 ml deionized water was added slowly. Later, the reaction mixture was further stirred at 80° C. for 2 hours to obtained copolymer MA-AA.

Synthesis of MA-AA-AEP polymer: To the above MA-AA copolymer solution, 2-aminoethylpiperazine (AEP) (0.306 mol) was added slowly and stirred at 80° C. for 2 hours. The obtained polymer (MA-AA-AEP) is characterized using GPC, FT-IR.

Synthesis of MA-AA-MEA polymer: To the above MA-AA copolymer solution, monoethanolamine (MEA) (0.306 mol) was added slowly and stirred at 80° C. for 2 hours. The obtained polymer (MA-AA-MEA) is characterized using GPC, FT-IR.

Synthesis of MA-AA-TA polymer: To the above MA-AA copolymer solution, tallow amine (TA) (0.306 mol) was added slowly and stirred at 80° C. for 2 hours. The obtained polymer (MA-AA-TA) is characterized using GPC, FT-IR.

### Performance Evaluation of Descaling Formulation:

Field scale samples collected from cooling tower water systems.

Static solubility test and procedure: This test was used to evaluate the dissolution efficiency of in-house descaling formulations against the field scales. A known amount (W1) of scale sample was taken into a beaker. Selected descaling formulation was added into the beaker and reaction mixture was heated to 70° C. Then, the reaction mixture was stirred at 300 rpm for 6 h at 70° C. At the end of the reaction, reaction mixture was cooled to room temperature and filtered to collect the undissolved scale sample, dried at 150° C., and weighed (W2). The dissolution efficiency was calculated by below equation.

$$\% scale dissolution efficiency = [ ( W 1 - W 2 ) / W 1 ] \times 100$$

Field scale sample was selected to evaluate performance of our descaling formulations for scale dissolution. Field scale sample was analyzed for elemental content by X-ray fluorescence (XRF) spectrometer and results showing major elements present and weight percent in the field scale sample were given in Table-1.

TABLE 1
Elemental content of the field scale sample

| Element | Ca | Fe | Si | Sr | Mg | Cu | Al | P | K |
|---|---|---|---|---|---|---|---|---|---|
| Content | 36.1 | 1.5 | 1.06 | 0.29 | 0.28 | 0.02 | 0.02 | 0.02 | 0.01 |
| (% wt.) | | | | | | | | | |

Most of the field scale samples include the carbonate, bicarbonate, oxide, hydroxide, phosphate, and sulphate of the elements as provided in the above table-1, especially, the field scale samples contain major portion of the calcium carbonate.

Performance evaluation experiments were carried out using about 10 g of field sample and 100 ml of descaling formulations. The results were given in Table-2 and Table-3. Table-2 provides descaling formulations having mineral acids, polymers (MA-AA-AEP polymer and MA-AA Co-polymer), surfactants, and corrosion inhibitors. Table-3 provides descaling formulations having mineral acids, organic acids, polymers (MA-AA-MEA polymer and MA-AA-TA polymer), surfactants, and corrosion inhibitors.

TABLE 2
Descaling efficiency of various formulations

| | Examples | | | | | | | | | | | | | | | | |
|---|---|---|---|---|---|---|---|---|---|---|---|---|---|---|---|---|---|
| Components (%) | 1 | 2 | 3 | 4 | 5 | 6 | 7 | 8 | 9 | 10 | 11 | 12 | 13 | 14 | 15 | 16 | 17 |
| Sulphamic acid | 10 | 10 | 10 | 10 | 10 | 10 | 10 | 10 | 10 | 10 | 10 | 10 | 10 | 10 | 10 | 10 | 10 |
| HCl | 5 | 5 | 5 | 5 | — | 5 | 5 | 5 | 5 | 5 | 5 | 5 | 5 | 5 | 5 | 5 | 5 |
| MA-AA-AEP polymer | | 2 | | 2 | | | | | | | | | | | | | |
| MA-AA Co-polymer | | | | | | 0.5 | 1.5 | 0.5 | 0.5 | 0.5 | | 0.5 | 0.5 | 0.5 | 0.5 | 0.5 | 0.5 |
| Cocamidopropylbetaine (CAPB) | | | 5 | 5 | 5 | | | 5 | 0.5 | | | | | | | | |
| Tergitol | | | | | | | | | | 1 | 0.5 | 0.5 | | | | | |
| Benzalkonium chloride | | | | | | | | | | | | | 0.1 | 0.5 | | | |
| Triton-X 100 | | | | | | | | | | | | | | | 0.05 | 0.2 | 0.5 |
| Water | 85 | 83 | 80 | 78 | 85 | 84.5 | 83.5 | 79.5 | 84 | 83.5 | 84.5 | 84 | 84.4 | 84 | 84.45 | 84.3 | 84 |
| Dissolution efficiency (%) | 61 | 72 | 68 | 58 | 56 | 78 | 79 | 62 | 76 | 66 | 74 | 70 | 68 | 69 | 78 | 81 | 75 |

TABLE 3
Descaling efficiency of various formulations

| | |
|---|---|
| Components | Examples |

| (%) | 18 | 19 | 20 | 21 |
|---|---|---|---|---|
| Sulphamic acid | 10 | 10 | 0 | 0 |
| HCl | 5 | 5 | 5 | 5 |
| Citric acid | 0 | 0 | 10 | 0 |
| Oxalic acid | 0 | 0 | 0 | 10 |
| MA-AA-AEP | 0 | 0 | 0 | 0 |
| polymer | | | | |
| MA-AA Co- | 0 | 0 | 0.5 | 0.5 |
| polymer | | | | |
| MA-AA-MEA | 0.5 | 0 | 0 | 0 |
| polymer | | | | |
| MA-AA-TA | 0 | 0.5 | 0 | 0 |
| polymer | | | | |
| Cocamidopropyl | 0 | 0 | 0 | 0 |
| betaine (CAPB) | | | | |
| Tergitol | 0 | 0 | 0 | 0 |
| Benzalkonium | 0 | 0 | 0 | 0 |
| chloride | | | | |
| Triton-X 100 | 0.2 | 0.2 | 0.2 | 0.2 |
| Water | 84.3 | 84.3 | 84.3 | 84.3 |
| Dissolution | 71 | 73.5 | 62 | 65 |
| efficiency (%) | | | | |

Accordingly, from the above table 2 and example 16 it can be concluded that the descaling formulation have excellent dissolution efficiency of 81% when the sulphamic acid is 10 parts by weight, HCl is 5 parts by weight, MA-AA Co-polymer is 0.5 parts by weight, Triton-X 100 is 0.2 parts by weight and water is 84.3 parts by weight. However, in the examples 15, 17 and 14 have lower dissolution efficiency of 78%, 75%, and 69% respectively only due to the slight variation in the composition of the descaling formulation.

Addition of polymer based surfactant (i.e. MA-AA-AEP) to acidic components (in Example-2) and addition of CAPB to acidic components (in Example-3) has increased the scale dissolution efficiency from 61% to 72% and 68% respectively. However, combination of acidic components, CAPB and polymer based surfactant (MA-AA-AEP) as described in Example-4 has shown poor result and dissolution efficiency dropped to 58%. It was found that copolymer MA-AA in combination with acidic components (Example-6 & 7) has shown better results compared to that MA-AA-AEP polymer.

This might be result of better compatibility of MA-AA copolymer compared to MA-AA-AEP with acidic components. It was also found that MA-AA copolymer, a polymer surfactant, has shown better result compared to CAPB, tergitol surfactants. Triton-X 100 can serve as surfactant as well as corrosion inhibitor.

Later, two different class of corrosion inhibitors, Benzalkonium chloride (quaternary ammonium salt) and Triton-X 100, were added and tested to improve the anticorrosion effects of the formulations. It was found that Triton-X 100 added formulation has shown better scale dissolution efficiency compared to Benzalkonium chloride. Examples-15, 16 and 17 focused to optimize Triton-X 100 dosage and found that 0.2 parts by weight dosage showed better result compared to 0.05 parts by weight and 0.5 parts by weight.

Thus, a suitable descaling formulation comprising of 10 parts by weight of sulphamic acid, 5 parts by weight of HCl, 0.5 parts by weight of MA-AA Co-polymer, 0.2 parts by weight of Triton-X 100 and 84.3 parts by weight of water has shown the best dissolution efficiency of 81%.

### Field Trial Experiment:

The industrial water system includes condensers and conventionally the descaling process of a condenser includes steps of chemical circulation, then brushing of the tubes and finally removing the leftover scales through water jetting. The conventional descaling process is described hereinafter. Initially, the inlet and outlet connections of the condensers are connected through a pump by using hosepipes with fittings. Bring both the inlet and outlet hose connections in contact with a container filled with the fresh plain water, so that the fresh plain water start circulating through the condenser pipes. Once the water comes out from the outlet hose from the condensers then the descaling chemical is added. Further, slowly adding the required quantity of the descaling chemical (based on the holdup volume 3-5%) and circulating for 4-5 hours. When this activity is completed, the complete water is drained out and fresh softened water is filled and then brushing is performed. Followed by the brushing activity, again chemical circulation is started. This procedure of addition of the descaling chemical, circulation and then brushing is repeated for three times. Once the descaling activity is completed, the next step is to start the physical cleaning of condenser tubes using water jetting. Water jetting is done and after that condenser boxing up is completed.

### Application of the Descaling Formulation:

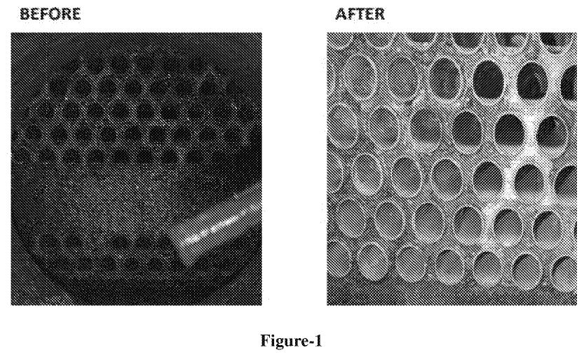

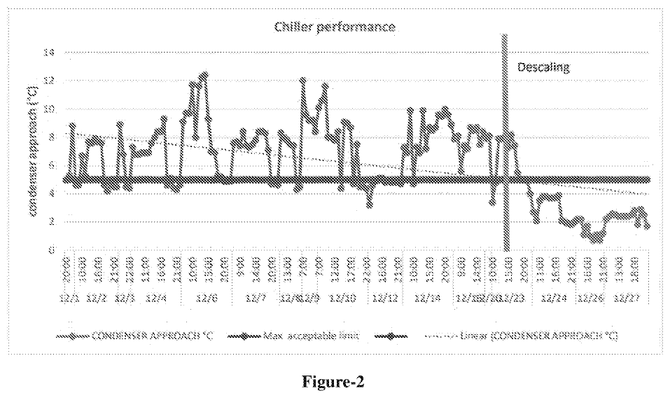

The above descaling approach is applied along with the descaling formulations as provided in the present disclosure. The observation regarding the descaling efficiency is provided in the FIG. 1, wherein, the condenser pipes before and after the application of the descaling formulations are shown. The condenser pipes show that most of the scale are dissolved and cleaned during the chemical circulation process itself and thus little efforts are required during brushing of the tubes. Further, the graph presented in FIG. 2 indicates the improvement of condenser approach and resulted in the condenser approach <5 degree Celsius. The normal acceptable range of condenser approach is 0-5 degree Celsius.

1. A descaling formulation to dissolve a scale deposit formed on a surface of an industrial water system, wherein, the descaling formulation comprising:
5 to 15 parts by weight of a dealkalizer selected from an acid component;
0.05 to 5 parts by weight of a surfactant selected from a polymer surfactant, a zwitter ionic surfactant, a non-ionic surfactant or a combination thereof;
0.05 to 0.5 parts by weight of a corrosion inhibitor selected from a quaternary ammonium salt, or a Polyethylene glycol alkyl ether; and
78 to 85 parts by weight of water.

2. The descaling formulation as claimed in claim 1, wherein, the said acid component consists of a mineral acid, an organic acid, or a combination thereof.

3. The descaling formulation as claimed in claim 2, wherein, the mineral acid is selected from Sulphamic acid, Hydrochloric acid, Sulfuric Acid, Nitric acid, Phosphoric acid, Sulfonic acid, or a combination thereof.

4. The descaling formulation as claimed in claim 2, wherein, the organic acid is selected from citric acid, oxalic acid, or a combination thereof.

5. The descaling formulation as claimed in claim 1, wherein, the polymer surfactant is selected from a maleic anhydride-acrylic acid copolymer (MA-A A copolymer), or a polymer of the MA-AA copolymer.

6. The descaling formulation as claimed in claim 1, wherein, the polymer of the MA-AA copolymer is a reaction product of an MA-AA copolymer with one of compound selected from ethyleneamines, tallow amines, alkanolamines at a reaction temperature of 50°-80° C. for 1-3 hours.

7. The descaling formulation as claimed in claim 1, wherein, the zwitter ionic surfactant is Cocamidopropylbetaine (CAPB).

8. The descaling formulation as claimed in claim 1, wherein, the non-ionic surfactant is Tergitol.

9. The descaling formulation as claimed in claim 1, wherein, the quaternary ammonium salt is benzalkonium chloride.

10. The descaling formulation as claimed in claim 1, wherein, the Polyethylene glycol alkyl ether is Triton-X 100.

11. The descaling formulation as claimed in claim 1 comprising 10 parts by weight of Sulphamic acid, 5 parts by weight of Hydrochloric acid, 0.5 parts by weight of MA-AA copolymer, 0.05-0.5 parts by weight of Triton-X 100, and 78 to 85 parts by weight of water.

12. A method to dissolve and clean a scale deposit formed on a surface of an industrial water system, wherein, the said method comprising the step of applying the descaling formulation as claimed in claim 1-14 on the surface of the industrial water system.

13. The method as claimed in claim 12, wherein the descaling formulation is circulated along with a liquid medium contacting the surface of the industrial water system, wherein, the said liquid medium is selected from a fresh water, a saline water, or a combination thereof.

14. The method as claimed in claim 12, wherein, the descaling formulation is circulated through the industrial water system, wherein, the descaling formulation is in direct contact with the surface of the industrial water system.
